(19) United States
(12) Patent Application Publication
(10) Pub. No.: US 2007/0065159 A1
(43) Pub. Date: Mar. 22, 2007

(54) All-optical 2R regenerator for multi-channel communication

(76) Inventors: Dmitri Vladislavovich Kuksenkov, Painted Post, NY (US); Hasan Imamus Saleheen, Painted Post, NY (US)

Correspondence Address: CORNING INCORPORATED, SP-TI-3-1, CORNING, NY, 14831, US

(21) Appl. No.: 11/233,566

(22) Filed: Sep. 22, 2005

(51) Int. Cl. H04B 10/00

(52) U.S. Cl. 398/175

(57) ABSTRACT

An optical 2R regenerator includes a decreasing dispersion optical fiber (DDF), or a Raman pump, or both.

### TECHNICAL FIELD

The present teachings relate generally to optical communications and particularly to an apparatus and method of re-shaping and re-amplifying of an optical signal.

### BACKGROUND

Signal regenerators play an important role in modern long distance optical communication systems. In general, optical regenerators are used to periodically restore the quality of optical data signals that have been distorted and/or attenuated in the course of transmission. An optical regenerator typically performs at least the functions of re-shaping optical data signals to remove random noise, and re-amplifying the optical data signals to restore their amplitude. An optical regenerator performing the re-shaping and re-amplifying functions is called a 2R regenerator.

Most contemporary signal regenerators employ costly and complicated optoelectronic devices, which transform data signals from the optical domain to the electrical domain before reshaping, re-amplifying, and retransforming them back into the optical domain for retransmission. An attractive alternative to using optoelectronic devices is to perform signal regeneration entirely in the optical domain using an all-optical regenerator.

All-optical regenerators provide at least two advantages over optoelectronic devices. First, they are significantly less expensive; and second, they allow wavelength routing to take place entirely in the optical domain. These and other advantages make all-optical regenerators the preferred choice for next generation optical communication systems.

One proposed approach for performing all-optical 2R regeneration is described in U.S. Pat. No. 6,141,129. This approach uses self phase modulation (SPM) related spectral broadening created by passing return-to-zero (RZ) data signals through a nonlinear transmission medium. Data signals passed through the nonlinear transmission medium are filtered by a band-pass optical filter having a passband offset from the original wavelength of the data signals. Data signals experiencing only a small amount of spectral broadening (i.e. signals having intensity below a certain threshold) are treated as noise and removed by the filter, whereas data signals experiencing a relatively large amount of spectral broadening are treated as valid data and equalized by the filter. In other words, the transfer function of the pass-band filter is approximately a step function, which reduces data signals below a certain amplitude to logic “0” setting data signals above a certain amplitude to logic “1.”

One significant shortcoming of existing approaches to all-optical 2R regeneration includes the lack of multi-channel operation. Particular obstacles to performing multi-channel operation with existing approaches include nonlinear effects such as four wave mixing (FWM), cross phase modulation (XPM), and parametric amplification of noise. These nonlinear effects have a tendency to drown out the useful effects of SPM.

FWM is an interaction between two or more channels in a multi-channel system resulting in distortion of data signals carried by the system. The amount of distortion caused by FWM changes with the amount of dispersion in the optical fiber. In particular, where dispersion is less than a certain minimum level, FWM causes distortion in data signals to the extent that it is exceedingly difficult for the signals to be distinguished from noise using available means. On the other hand, FWM can be avoided by using an optical fiber with sufficient dispersion.

Unfortunately, many single-channel 2R regeneration approaches do not work unless the dispersion is below the minimum level required for multi-channel operation. For example, where the above described approach using SPM based spectral broadening is used with normal dispersion fiber (i.e., fiber whose dispersion is of the type in which the effective index increases with the optical frequency, often referred to as negative dispersion fiber), increasing the dispersion of the fiber beyond a certain point causes optical pulse widths of the data signals to broaden as their spectrum is broadened, leading to an effect known as inter-symbol interference. Inter-symbol interference occurs where neighboring optical pulses develop significant overlap, thereby causing nonlinear effects such as intra-channel FWM and intra-channel XPM. These nonlinear effects quickly degrade the quality of the data signals, thereby making it impossible to increase the dispersion of a normal or negative dispersion fiber enough to achieve multi-channel operation. As a result, normal or negative dispersion fiber cannot be used in a multi-channel 2R regenerator.

Inter-symbol interference is not a significant problem, however, in anomalous dispersion fiber (i.e., fiber whose dispersion is of the type in which the effective index decreases with the optical frequency, often referred to as positive dispersion fiber) because dispersion and SPM balance each other, causing pulses to compress. Hence, anomalous or positive dispersion fiber can be used in a multi-channel 2R regenerator based on SPM-related spectral broadening.

XPM is another interaction between two or more channels in a multi-channel system resulting in distortion of data signals. An instance where XPM introduces distortion is where optical pulses of different channels enter a nonlinear fiber of a 2R regenerator nearly simultaneously. This is not uncommon in optical communication systems since relative clock delays between channels at a given time are typically random. Where optical pulses of two different channels enter the nonlinear fiber nearly simultaneously, they travel together for most of its length, if the dispersion walk-off is small. As a result, a nonlinear phase shift and related spectral broadening caused by SPM in each channel is approximately the same as that caused by XPM between the two channels. Where this is the case, spectral broadening cannot be used to perform regeneration.

XPM can be avoided by using an optical fiber of length sufficient to cause optical pulses of different channels to run through each other, or fully collide. Because signals with different wavelengths travel at different speeds, where an optical fiber is long enough, a slower pulse that begins traveling in front of another pulse will end up behind its neighbor by the time it reaches the end of the optical fiber. This event, called collision, ensures that the effects of XPM are minimal.

From the above discussion it can be concluded that in order to simultaneously overcome the effects of FWM and XPM in a multi-channel optical 2R regenerator, anomalous or positive dispersion optical fiber having sufficient dispersion and sufficient length must be used. Unfortunately, however, these conditions by themselves will not enable multi-channel optical 2R regeneration.

In order to achieve sufficient spectral broadening to perform multi-channel 2R regeneration in anomalous dispersion optical fiber, the input signal power needs to be at least twice that of a fundamental solution. Unfortunately, however, providing a high-power input signal to an anomalous dispersion fiber typically leads to parametric amplification of noise, which will distort data signals beyond recognition. This is a problem which previous approaches have failed to address, or even recognize.

What is needed, therefore, is an optical 2R regenerator that overcomes at least the shortcomings of the previous approaches. A desired characteristic for such a regenerator is the ability to operate at a lower input power so as to eliminate parametric amplification of noise while still providing sufficient dispersion to minimize FWM and sufficient length to minimize XPM.

### SUMMARY

As used herein, the terms ‘a’ or ‘an’ means one or more, and the term ‘plurality’ means at least two.

In accordance with an example embodiment, an optical regenerator includes an optical amplifier and an anomalous dispersion optical fiber which receives an input signal from the optical amplifier. The anomalous dispersion optical fiber has a decreasing dispersion along a length that compresses the duration or width of the optical pulses that make up the input signal, by at least a factor of approximately 2.0. A bandpass filter then receives the output signal from the optical fiber.

In accordance with yet another example embodiment, a method of regenerating an optical signal includes providing an optical amplifier for receiving the optical signal and producing an output optical signal. The method also includes receiving the output optical signal from the optical amplifier in an anomalous dispersion optical fiber having decreasing dispersion along a length of the fiber that compresses the duration or width of the optical pulses that make up that optical signal, by at least a factor of approximately 2.0. The method also includes receiving the output optical signal from the optical fiber in a bandpass filter.

### BRIEF DESCRIPTION OF THE DRAWINGS

The invention is best understood from the following detailed description when read with the accompanying drawing figures. It is emphasized that various features are not necessarily drawn to scale. In fact, the dimensions may be arbitrarily increased or decreased for clarity of discussion.

FIG. 1 is an illustration showing a long distance communication system including a 2R regenerator.

FIG. 2 is a circuit diagram illustrating an optical 2R regenerator in accordance with an example embodiment.

FIG. 3 is a circuit diagram illustrating an optical 2R regenerator in accordance with another example embodiment.

FIG. 4 is a circuit diagram illustrating an optical 2R regenerator in accordance with another example embodiment.

FIG. 5 is a circuit diagram illustrating an optical 2R regenerator in accordance with still another example embodiment.

FIG. 6 is a graph showing an optimal dispersion versus length profile for an optical fiber in an optical 2R regenerator.

FIG. 7 is a graph showing output versus Q factor of a middle channel in accordance with an example embodiment.

FIG. 8 is a graph showing Q-factor dependence on residual dispersion of an input signal of a middle channel in accordance with an example embodiment.

### DETAILED DESCRIPTION

In the following detailed description, example embodiments disclosing specific details are set forth in order to provide an understanding of the present teachings. The example embodiments are set forth for purposes of explanation and not limitation. Those of ordinary skill in the art will understand that various changes in form and details may be made to the example embodiments without departing from the scope of the appended claims. Moreover, descriptions of well-known devices, methods and systems may be omitted so as to not obscure the description of the example embodiments. Nonetheless, such devices, methods and systems that are within the purview of those of ordinary skill in the art may be used in accordance with the example embodiments.

Briefly, and as described in conjunction with example embodiments herein, an optical 2R regenerator includes an anomalous dispersion optical fiber with substantially constant dispersion and a Raman pump, which launches a pumping light in a direction opposite to that of the propagating signal. This is often referred to as a backward-pumping Raman pump. Alternatively, the optical 2R regenerator includes an anomalous dispersion optical fiber with decreasing dispersion along its length (referred to hereinafter as a decreasing dispersion optical fiber or DDF). Still alternatively, the optical 2R regenerator includes a DDF with the backward-pumping Raman pump. The substantially constant anomalous dispersion optical fiber is typically a highly nonlinear dispersion-shifted fiber (HNL-DSF) and the dispersion in the DDF is typically decreased by varying the diameter of the DDF or using variable doping in the core of the optical fiber.

Beneficially, the optical 2R regenerator achieves multiple wavelength division multiplexed (WDM) channel 2R regeneration by solution effect pulse compression and subsequent narrowband filtering. The solution effect pulse compression causes sufficient SPM related spectral broadening so that narrowband filtering can be effectively employed to remove noise from data signals while keeping the data signals intact.

Specific details will now be set forth with respect to example embodiments depicted in the attached drawings. It is noted that like reference numerals refer to like elements.

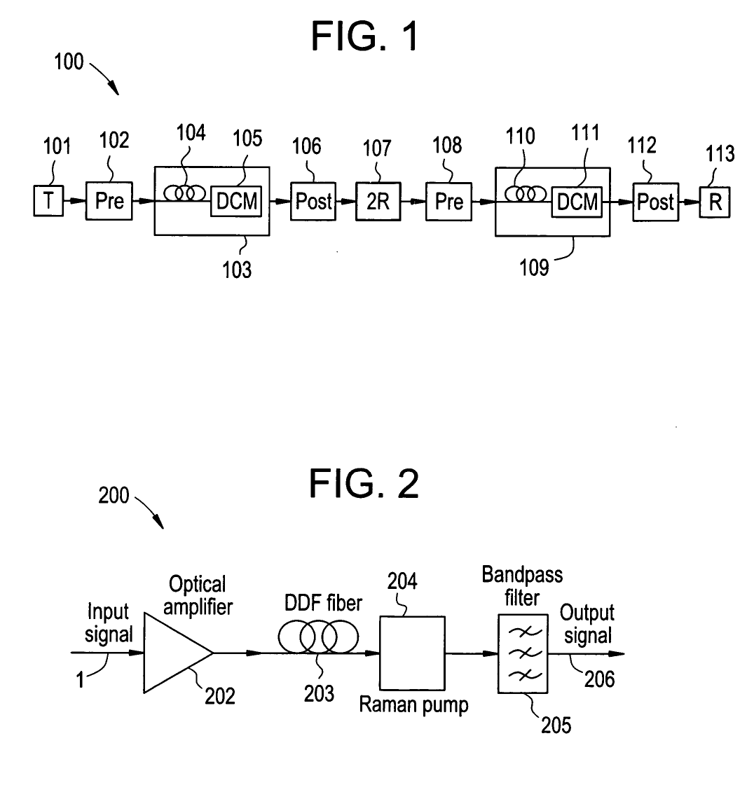

FIG. 1 is a block diagram of a long distance communication system 100 including an optical 2R regenerator in accordance with an example embodiment. The long distance communication system 100 includes a transmission unit 101, pre-processing units 102 and 108, amplifier spans 104 and 110, dispersion compensation modules (DCM) 105 and 111, post-processing units 106 and 112, an optical 2R regenerator 107, and a receiver unit 113. The pre-processing units 102 and 108 include known filters, or amplifiers, or both. Likewise, the post-processing units 106 and 112 include known filters.

The DCMs 105 and 111 may be fiber-based dispersion compensation modules such as described in commonly assigned U.S. Patent Publication 20040101241 to Kohnke, et al. and commonly assigned U.S. Patent Publication 20020181879 to Bickham, et al., the disclosures of which are specifically incorporated herein by reference. It is emphasized that the noted DCMs are merely illustrative and that other types of DCMs known to one of ordinary skill in the art may be incorporated as DCMs 105 and 111.

Illustratively, optical 2R regenerator 107 is embedded in a long distance communication system 100. Moreover, the long distance communication system 100 may operate at approximately 40 Gb/s and may comprise ten channels spaced at 200 GHz. Each amplifier span is illustratively 80 km long and is followed by a DCM. For example, the optical 2R regenerator 107 may be placed after seven amplifier spans (560 km) in the system.

FIG. 2 is a circuit diagram of an optical 2R regenerator 200 in accordance with an example embodiment. Notably, the optical 2R regenerator 200 may be used as the 2R regenerator 107 of the example embodiment described previously.

The optical 2R regenerator includes an optical amplifier 202, a DDF 203, a backward-pumping Raman pump 204, and a band-pass filter 205. The optical 2R regenerator receives an input signal 201 and transmits an output signal 206. In a specific embodiment, the DDF 203 is replaced with an anomalous dispersion fiber having a substantially constant dispersion. In another specific embodiment, the Raman pump 204 is omitted.

The dispersion in the DDF 203 is typically decreased by varying the core diameter of the fiber or using variable doping in the core of the optical fiber. In the present example embodiment in which both the DDF 203 and the Raman pump 204 are incorporated, the dispersion decreases over the length of the fiber by a factor of more than approximately 1.0 and less than approximately 10.0. In a specific embodiment, the dispersion decreases by a factor of approximately 3.0. In another specific embodiment, the DDF provides a change in dispersion of approximately 17.0 ps/nm/km to approximately 1.7 ps/nm/km, or a ten-fold reduction. In yet another specific embodiment, and as described below, the change in the dispersion is from approximately 8.4 ps/nm/km to approximately 2.6 ps/nm/km, or a factor of 3.23.

The optical amplifier 202 amplifies input signal 201, which is received by and transmitted across DDF 203. DDF 203 compresses the duration or width of the optical pulses that make up the input signal 201 due to its decreasing dispersion. Raman pump 204 is a known, backward-pumping device, which is coupled to the output of the DDF 203 as shown. The Raman pump 204 usefully compresses optical pulses in input signal 201 by increasing its power via backward pumping.

Illustratively, Raman pump 204 provides an optical power of more than approximately 10.0 mW and generally less than about 1.0 W at one or several wavelengths in the wavelength range of approximately 1420 nm to approximately 1470 nm for those systems where optical signals are in the range of 1530 nm to 1570 nm.

In the present example embodiment, the output of the DDF 203 is input to a bandpass filter 205, which performs a narrowband filtering function on input signal 201 and provides an output signal 206.

The DDF 203 and the optical gain produced by Raman pump 204 produce solution effect pulse compression with input signal power equal to that or even less than fundamental solution power, thereby minimizing distortion caused by parametric amplification of noise. Since the solution pulse power is directly proportional to fiber dispersion and inversely proportional to pulse width, decreasing fiber dispersion using DDF 203 or increasing signal power using a Raman pump 204, or a combination thereof, causes signal pulses traveling through the optical 2R regenerator to dynamically compress in propagation, beneficially with a higher resultant quality than can be achieved in a constant dispersion fiber with no gain.

The optical 2R regenerator typically achieves solution effect pulse compression of approximately twice (2×) to approximately four times (4×) relative to input pulse width prior to narrowband spectral filtering. Notably, for transform-limited pulses, the spectral width is inversely proportional to the pulse width in time. True solutions are transform-limited, and therefore for solutions, compression of approximately 2× to approximately 4× in time is equivalent to an approximately 2× to approximately 4× broadening of the spectrum. RZ format transmission signal pulses are not true solutions, they might have Gaussian or Sin² shape, but the produced amount of spectral broadening will be similar.

The band-pass filter 205, having multiple passbands, is used to perform narrowband spectral filtering on different communication channels. Such a filter is typically constructed using an optical circulator and multiple Fiber Bragg Grating (FBG) reflectors. Alternatively, the band-pass filter 205 can also be an Arrayed Waveguide Grating router (AWG) or a thin-film device based on a Fabry-Perot etalon, or a fiber Fabry-Perot (FFP) etalon, all of which are well within the scope of knowledge of one of ordinary skill in the art.

In the present example embodiment incorporating a DDF 203 and a Raman pump 204 in the 2R regenerator, the combined effect results in pulse compression of at least approximately 2× and less than approximately 4×. In a specific embodiment, a compression of approximately 3× is realized. For the case when input signal power is equal to that of a fundamental solution for the front end of the nonlinear fiber, 3× compression is achieved if the power is increased by 3×; or dispersion is decreased by 3×; or power is increased and dispersion is decreased, both by 1.73×(1.732=3). Notably, for a lower input signal power, a larger magnitude of dispersion decrease and/or power increase is provided to produce 3× compression.

As described previously, the dispersion of the DDF 203 decreases by a factor of approximately 1.0 to approximately 10.0; and in a specific embodiment, the dispersion decreases by a factor of approximately 3.0 to approximately 4.0. The power should not increase by more than four times, as this may be counterproductive to using lower power for spectral broadening. Moreover, for the case of no Raman pumping, the power increase is actually negative due to power loss in the fiber. Accordingly, the change in the power is by a factor of approximately −2.0 to approximately +4.0. In a specific embodiment, the Raman gain cancels the fiber attenuation, and power is approximately constant throughout the fiber, or the power increase is nullity.

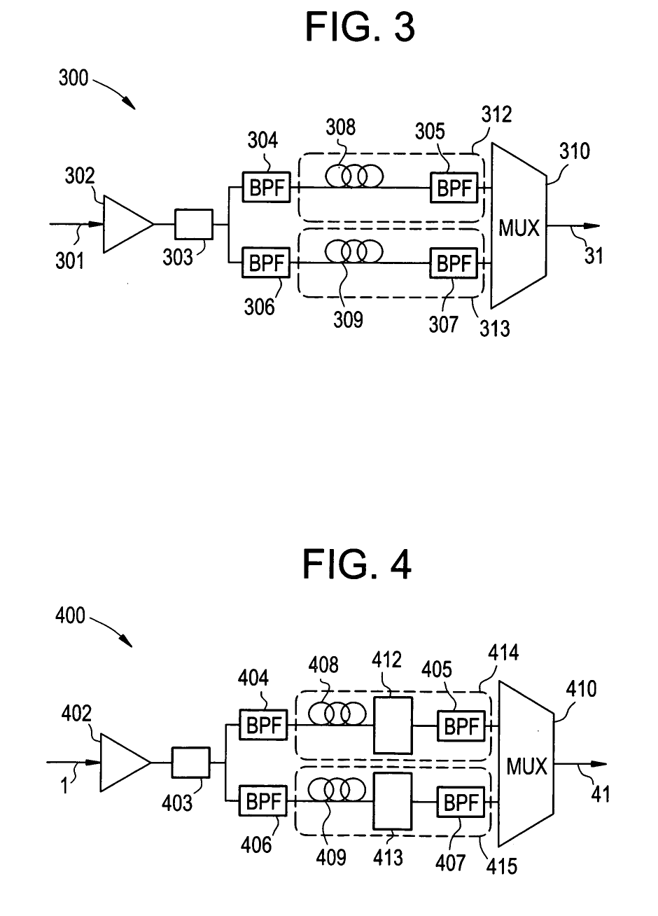

FIG. 3 is a circuit diagram illustrating a regenerator module 300 in accordance with another example embodiment. Illustratively, the regenerator module 300 may function as the 2R regenerator 107 of the example embodiment of FIG. 1. Regenerator module 300 includes a pre-amplifier 302, an interleaver 303, band-pass filters 304, 305, 306, and 307, DDFs 308 and 309, and a multiplexer 310. Regenerator module 300 receives an input signal 301 and transmits an output signal 311. Notably, the regenerator module 300 does not include a Raman pump.

Illustratively, pre-amplifier 302 boosts the power of input signal 301 to produce nonlinear effects in DDFs 308 and 309. Pre-amplifier 302 is typically an erbium-doped fiber amplifier (EDFA). Interleaver 303 separates input signal 301 into odd and even channels, which pass through optical 2R regenerators 312 and 313 respectively in order to increase channel spacing to reduce XPM. Channel spacing in each regenerator is typically approximately 400 GHz. Channels passing through regenerators 312 and 313 are combined through multiplexer 310 and launched into a next span as output signal 311. DDFs 308 and 309 cause data pulses in input signal 301 to compress as input signal 301 travels through the DDFs. The compression is due to decreasing dispersion in DDFs 308 and 309 along their lengths. In the present example embodiment, the dispersion decreases to approximately one-fourth to approximately one-third of the starting value.

FIG. 4 is a circuit diagram illustrating a regenerator module 400 in accordance with another example embodiment. Regenerator module 400 includes a pre-amplifier 402, an interleaver 403, band-pass filters 404, 405, 406, and 407, HNL-DSFs 408 and 409, Raman pumps 412 and 413, and a multiplexer 410. Regenerator module 400 receives an input signal 401 and sends an output signal 411. As before, the regenerator module 400 may be incorporated as the 2R regenerator 107 of the example embodiment of FIG. 1. In the present example embodiment, the DDF is replaced by an anomalous dispersion fiber having a substantially constant dispersion.

Raman pumps 412 and 413 are backward pumping devices as previously described. The pumps increase the signal power. In a specific embodiment, each of the Raman pumps 412 and 413 increase the signal power at the output of the HNL-DSFs. In example embodiments, the power increases by a factor of approximately −2.0 to approximately +4.0; and in a specific embodiment by a factor of approximately 0.0 (i.e., the power remains approximately constant).

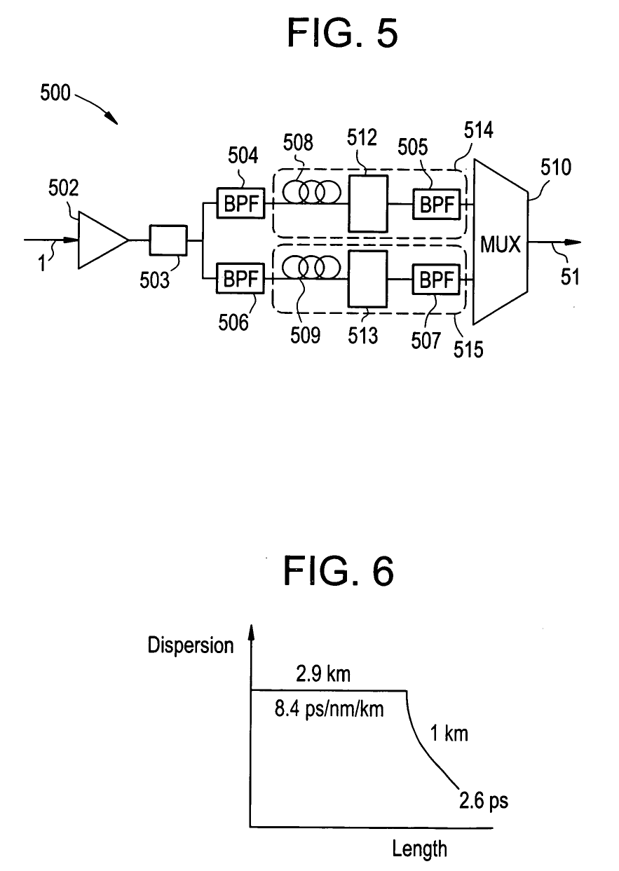

FIG. 5 is a circuit diagram illustrating a regenerator module 500 in accordance with still another example embodiment. Regenerator module 500 includes a pre-amplifier 502, an interleaver 503, band-pass filters 504, 505, 506, and 507, DDFs 508 and 509, Raman pumps 512 and 513, and a multiplexer 510. Regenerator module 500 receives an input signal 501 and sends an output signal 511.

Regenerator module 500 functions similarly to regenerator module 200 in FIG. 2, but rather includes additional bandwidth capability via the interleaver 503. The interleaver 503 separates input signal 501 into odd and even channels, in order to increase channel spacing to reduce XPM. Channel spacing in each regenerator is typically approximately 400 GHz. After regeneration, the even and odd channels are recombined through multiplexer 510 and launched to a next span as output signal 511.

DDF 508 compresses even-channel data pulses as they travel through the DDF. Likewise, DDF 509 compresses odd-channel data pulses. The backward-pumping Raman pumps 512 and 513 then provide requisite gain to the signal thereby boosting the output power. Notably, the decrease in the dispersion and the increase in the power provided by the DDFs and the Raman pumps, respectively, are substantially the same as those described in connection with FIG. 2.

As described previously, optical fiber in a multi-channel optical 2R regenerator should have a length sufficient to let optical pulses of different wavelengths fully collide in order to minimize XPM. A length sufficient to let two pulses fully collide is defined as a collision length L_{coll}:

$${L}_{coll} = \frac{2 τ}{D Δ λ} , \qquad ( 1 )$$

where τ is a pulse width, D is fiber dispersion, and Δλ is a spectral separation of channels. As a simple, first order approximation to a design rule for a 2R regenerator, the nonlinear fiber length has to be greater than L_{coll}. To make this rule more general, “τ” is replaced with “T” and the total dispersion D×L of the nonlinear fiber has to be greater than 2T/Δλ. For example, for 40 Gb/s channels (T=25 ps) separated by 600 GHz (˜4.8 nm at 1550 nm), D×L has to be greater than 10 ps/nm.

An optimal dispersion versus length profile for the DDF (e.g., DDF 203) depends on several factors, for example, fiber attenuation, effective area, signal modulation format, and channel spacing. In numerical experiments using five 40 Gb/s CS-RZ channels separated by 600 GHz and nonlinear fiber with 15 μm² effective area and 0.5 dB/km attenuation, combined with a spectrally periodic (comb) 80 GHz wide third order Butterworth filter used as the output filter, suitable performance is achieved for a 3.9 km long nonlinear fiber with a dispersion map shown in FIG. 6. The dispersion is substantially a constant 8.4 ps/nm/km for the first 2.9 km and decreases exponentially from approximately 8.4 ps/nm/km to approximately 2.6 ps/nm/km in the last 1 km.

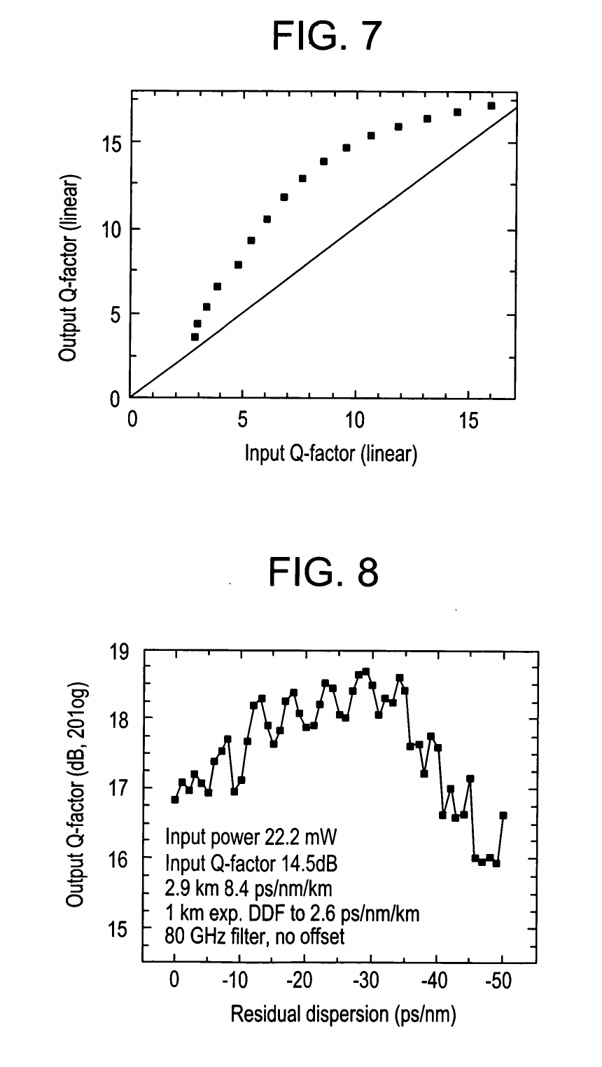

FIG. 7 represents the output versus Q factor of a middle channel. As is known, the better the device performance, the higher above the 45-degree line (representing no change) the data are located. In the specific embodiment shown, the largest improvement is for input Q-factors of approximately 7 to approximately 10. However, even for relatively poor quality, having a Q-factor of 3 (10.4 dB on a 20 log Q scale), an improvement of approximately 4 db is achieved. Equal or better performance is expected for the other four channels of the specific embodiment. In particular, the middle channel experiences the greater XPM penalty, thus the other four channels will attain equal or performance.

FIG. 8 is a graphical representation of the Q-factor dependence on the residual dispersion of the input signal of the middle channel. Oscillations shown are numerical artifacts produced by linear fiber dispersion. The best performance is predicted for residual dispersion in the range of approximately −12 ps/nm to approximately −35 ps/nm, with an average increase in Q of approximately 3.5 dB. Illustratively, providing a slight over-compensation of fiber dispersion is useful prior to the 2R regeneration. This may be effected by introducing a relatively short additional length of standard dispersion compensating fiber as a part of the 2R device. In the example embodiment of FIG. 1, the DCMs 105, 11 are so incorporated.

In view of this disclosure it is noted that the various methods, devices and parameters are included by way of example only and not in any limiting sense. In view of this disclosure, those skilled in the art can implement the various example devices and methods in determining their own techniques and needed equipment to effect these techniques, while remaining within the scope of the appended claims.

1. An optical regenerator, comprising:
an optical amplifier;
an anomalous dispersion optical fiber which receives an input signal containing optical pulses from the optical amplifier, said anomalous dispersion optical fiber having decreasing dispersion along a length that compresses the duration of said optical pulses by at least a factor of approximately 2.0, to produce an output signal; and
a bandpass filter that receives said output signal.

2. The optical regenerator of claim 1, wherein the dispersion decreases along the length by a factor of approximately 1.0 to approximately 10.0.

3. The optical regenerator of claim 1, further comprising a backward-pumping Raman pump.

4. The optical regenerator of claim 1, wherein the input signal comprises multiple channels.

5. The optical regenerator of claim 4, wherein the regenerator further comprises an optical interleaver, which separates the channels.

6. The optical regenerator of claim 1, further comprising a plurality of said anomalous dispersion optical fibers; a plurality of Raman pumps, each of which is associated with a corresponding one of said anomalous dipersion optical fibers; a plurality of bandpass filters, each of which receives an output signal from a corresponding one of said anomalous dispersion optical fibers; and a multiplexer which combines the output signals from said plurality of bandpass filters.

7. The optical regenerator of claim 1, wherein the dispersion decreases over a length by at least a factor of approximately 1.5.

8. The optical regenerator of claim 1, wherein the Raman pump increases power in the input signal by at least a factor of approximately 1.5.

9. The optical regenerator of claim 1, wherein the regenerator provides solution compression to the optical pulses by a factor of approximately 2.0 to approximately 4.0.

10. A method of regenerating an optical signal containing optical pulses, the method comprising:
providing an optical amplifier for receiving the optical signal and producing a first output optical signal;
receiving the first output optical signal from the optical amplifier in an anomalous dispersion optical fiber having decreasing dispersion along a length that compresses the duration of the optical pulses contained in said signal by at least a factor of approximately 2.0 and providing a second output optical signal; and
receiving the second output optical signal from said optical fiber in a bandpass filter.

11. The method of claim 10, wherein the dispersion decreases along the length by a factor of approximately 1.0 to approximately 10.0.

12. The method of claim 10, further comprising:
providing a Raman pump to backward-pump the anomalous dispersion optical fiber, to develop additional gain.

13. The method of claim 10, wherein the optical signal received by the optical amplifier comprises multiple channels.

14. The method of claim 10, wherein the optical pulses contained in the optical signal received by the anomalous dispersion optical fiber are compressed by at least a factor of approximately 3.0.

15. The method of claim 10, wherein the dispersion decreases by at least a factor of approximately 1.5.

16. The method of claim 12, further comprising providing a Raman pump to backward-pump the anomalous dispersion optical fiber, to develop additional gain.
